(19) United States
(12) Patent Application Publication
(10) Pub. No.: US 2010/0075280 A1
(43) Pub. Date: Mar. 25, 2010

(54) Educational game

(76) Inventor: Pamela Piton, Key Largo, FL (US)

Correspondence Address: PAMELA PITON, 640 CABRERA STREET, KEY LARGO, FL, 33037, US

(21) Appl. No.: 12/586,583

(22) Filed: Sep. 23, 2009

Related U.S. Application Data
(60) Provisional application No. 61/192,895, filed on Sep. 23, 2008.

(51) Int. Cl. G09B 19/22; A63F 3/00

(52) U.S. Cl. 434/128; 273/288

(57) ABSTRACT

A game includes a plurality of disparate game pieces and a tangible medium having instructions provided thereon. A plurality of game pieces each visually resembling a turtle are provided. Each one of the turtle resembling game pieces is distinctly identified for allowing each player of the game to be associated with a respective one of the turtle resembling game pieces. Also provided are a plurality of game pieces visually resembling a rock, one or more game pieces visually resembling a lily pad, and one or more game pieces visually resembling a cluster of cat-tails. The instructions are configured for specifying a manner in which the rock resembling game pieces, the one or more lily pad resembling game pieces and the one or more cat-tail cluster resembling game piece can be arranged to form a game path along which the turtle resembling game pieces are to be moved.

### CROSS REFERENCE TO RELATED APPLICATIONS

This patent application claims priority from co-pending United States Provisional Patent Application having Ser. No. 61/192,895, filed Sep. 23, 2008, entitled “Turtles Pond Rug Game”, having a common applicant herewith and being incorporated herein in its entirety by reference.

### FIELD OF THE DISCLOSURE

The disclosures made herein relate generally to games played using a variety of related game-pieces and, more particularly, to a game played upon a rug or floor mat having an impression of a pond provided thereon and with game-pieces that have the theme of items typically associated with a pond.

### BACKGROUND

Games played with theme-based game-pieces (e.g., board games) have a long history and are known to have been played in most cultures and societies for many years, even predating the development of literacy in some of the earliest civilizations. To a certain extent, the popularity of such games is based on the high degree of entertainment that is derived from the social interaction that comes from the combination of competition and comradery that is intrinsic to the game play. In addition to, and perhaps because of the entertainment value inherent in game playing, games played with game-pieces are useful as a forum for the development of many types of social cohesion, from family unity to community building, by cultures and communities throughout the world. Another social attribute of many such games is the ability to be used as an educational tool (e.g., education about academic subjects, about trivia, about history, etc). The various social and entertainment factors contributing to the historical success of board games also contribute to the board game being used as an effective teaching tool.

In a society that values education, tools to assist in learning are in demand for all age groups in all subject areas. For example, elementary school children use pictorial workbooks to learn basic mathematics. Tutoring programs are offered to high school students who may need extra help in chemistry. Preparatory courses and practice exam workbooks are available for university students preparing for qualification examinations to enroll in postgraduate programs. Regardless of age, skill level, and subject area, an effective method to learn is to make the learning process enjoyable and fun.

### SUMMARY OF THE DISCLOSURE

Embodiments of the present invention are games useful for entertainment and/or educational purposes. For example, a game configured in accordance with the present invention allows a teacher to change the content of such game (e.g., questions asked) so that that game is tailored to their curriculum and/or lesson plan. Furthermore, a game configured in accordance with the present invention can have certain game pieces arranged in different configurations such that a flow of the game is not the same each time it is played. Accordingly, it can be seen that a game configured in accordance with the present invention provides for a dynamic, entertaining and education game play experience.

In one embodiment of the present invention, a game comprises a plurality of disparate game pieces and a tangible medium having instructions provided thereon. A plurality of game pieces each visually resembling a turtle are provided. Each one of the turtle resembling game pieces is distinctly identified for allowing each player of the game to be associated with a respective one of the turtle resembling game pieces. Also provided are a plurality of game pieces visually resembling a rock, one or more game pieces visually resembling a lily pad, and one or more game pieces visually resembling a cluster of cat-tails. The instructions are configured for specifying a manner in which the rock resembling game pieces, the one or more lily pad resembling game pieces and the one or more cat-tail cluster resembling game piece can be arranged to form a game path along which the turtle resembling game pieces are to be moved.

In another embodiment of the present invention, a game comprises a game substrate, a plurality of disparate game pieces and a tangible medium having instructions provided thereon. The game substrate has provided thereon indicia visually representing a water body (e.g., a pond). Such indicia includes indicia visually resembling a plurality of rocks exposed at a surface of water of the water body, indicia visually resembling one or more logs exposed at the surface of the water, indicia visually resembling one or more lily pads exposed at the surface Of the water, and indicia visually resembling one or more cat-tail clusters exposed at the surface of the water. A plurality of first configuration game pieces each visually resembling a first life form inhabiting a water body is provided. Each one of the first configuration game pieces is distinctly identified for allowing each player of the game to be associated with a respective one of the first configuration game pieces. One or more second configuration game piece visually resembling a second life form inhabiting the water body is provided. The one or more second configuration game pieces each has provided thereon information designating an action to be taken by a player in response to the player answering a question correctly. A plurality of collectible game piece sets is provided. Each collectible game piece of a particular one of the collectible game piece sets is visually identifiable as belonging to the particular one of the collectible game piece sets. One or more third configuration game piece visually resembling a third life form inhabiting the water body are provided. The one or more third configuration game piece has provided thereon information designating at least one of the collectible game pieces to be collected by a player when a respective one of the first configuration game pieces of the player comes to rest on one of the third configuration game pieces during a play instance of the player. Also provided is instructions specifying a manner in which the second and third configuration game pieces can be arranged on the game substrate in conjunction with the indicia provided on the game substrate to form a game path along which the first configuration game pieces are to be moved.

In another embodiment of the present invention, a game comprises a plurality of disparate game pieces and a tangible medium having instructions provided thereon. A plurality of first configuration game pieces each visually resembling a first life form inhabiting a water body is provided. Each one of the first configuration game pieces is distinctly identified for allowing each player of the game to be associated with a respective one of the first configuration game pieces. One or more second configuration game piece visually resembling a second life form inhabiting the water body are provided. One or more third configuration game piece visually resembling a third life form inhabiting the water body is provided. A plurality of fourth configuration game pieces visually resembling a structure that extends above a surface of the water body and upon which the first life form can rest is provided. A tangible medium having instructions provided thereon is provided. The instructions specify a manner in which the one or more second configuration game pieces, the one or more third configuration game pieces, and the fourth configuration game pieces can be arranged to form a game path along which the first configuration game pieces are to be moved.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 shows a game piece collection configured in accordance with an embodiment of the present invention.

FIG. 2 shows path defining game pieces of the game piece collection of FIG. 1 arranged to form a game path in accordance with the present invention.

FIG. 3 shows a game substrate configured in accordance with an embodiment of the present invention.

### DETAILED DESCRIPTION OF THE DRAWING FIGURES

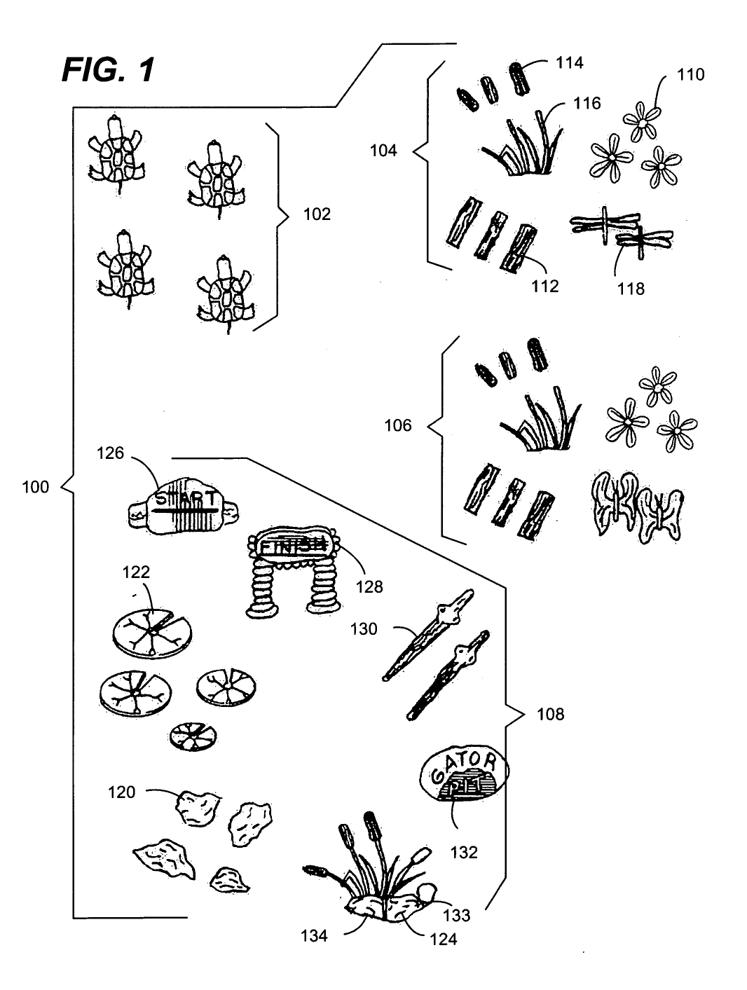

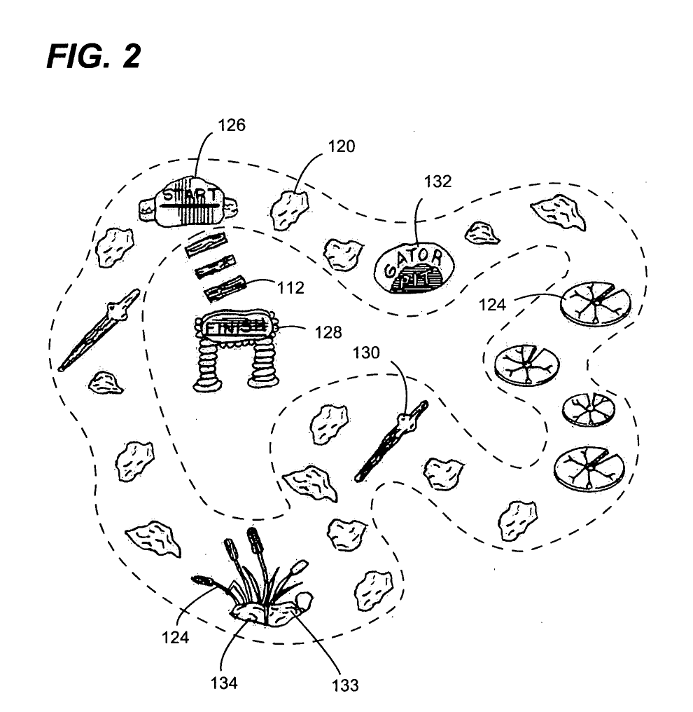

Referring to FIGS. 1 and 2, a game piece collection 100 suitably configured for playing a game in accordance with the present invention are shown. Such a game is useful for entertainment and/or educational purposes. For example, the game can allow a teacher to change the content of such game (e.g., questions asked) so that that game is tailored to their curriculum and/or lesson plan. Furthermore, the game can have certain game pieces arranged in different configurations such that a flow of the game is not the same each time it is played. Accordingly, it can be seen that the game provides for a dynamic, entertaining and education game play experience.

The game piece collection 100 includes a disparate assortment of game pieces necessary for setting up and playing a game in accordance with the present invention. In one embodiment, the game piece collection 100 includes a player indicating game piece set 102, a first collectible game piece set 104, a second collectible game piece set 106, and a path defining game piece set 108. As is discussed below in greater detail in reference to game play instructions, a game configured in accordance with the present invention would include a tangible medium (e.g., printed instructions, instructions on digital storage media, etc) having instructions that explain how the game piece sets 102, 104, 106, and 108 can be used to play a game.

Each game piece of the player indicating game piece set 102 is preferably, but not necessarily, distinctly identifiable for allowing each player of the game to be associated with a respective game piece of the player indicating game piece set 102. For example, each game piece of the player indicating game piece set 102 can have a unique number provided thereon and/or have a certain color provided thereon. In one embodiment, each game piece of the player indicating game piece set 102 visually resembles a turtle (i.e., turtle resembling game pieces), which is a life form that can inhabit a pond (i.e., a water body).

Each one of the collectible game piece sets 104, 106 can include a plurality of collectible game piece sets. Each collectible game piece of a particular one of the sets of collectible game pieces is visually identifiable as belonging to the particular one of the sets of collectible game pieces and wherein the instructions further specify a manner in which at least one of the game pieces of a particular set of the collectible game pieces is associated with the game path for winning the game. In one embodiment, each one of the collectible game piece sets 104, 106 can include a plurality of flower resembling game pieces 110, a plurality of bridge segment resembling game pieces 112, a plurality of cat-tail flower resembling game pieces 114, a plurality of cat-tail stem resembling game pieces 116, and a plurality of insect resembling game pieces 118. Color and/or shape of a particular collectible game piece can be used to distinguish between which particular collectible game piece set a particular game piece belongs. For example, the cat-tail flower resembling game pieces of different ones of the collectible came piece sets 104, 106 can be different colors, the bridge segment resembling game pieces 112 of different ones of the collectible came piece sets 104, 106 can be different colors, and the insect resembling game pieces of different ones of the collectible came piece sets 104, 106 can be different shapes (e.g., different species or genus of insect such as dragonfly and butterfly).

The path defining game piece set 108 can include a plurality of game pieces visually resembling a rock (i.e., rock resembling game pieces 120), one or more game pieces visually resembling a lily pad (i.e., lily pad resembling game piece 122), one or more game pieces visually resembling a cluster of cat-tails (i.e., cat-tail resembling game piece 124), a game piece including indicia designating a start location (i.e., a start location designating game piece 126), a game piece including indicia designating a finish location (i.e., a finish location designating game piece 128), one or more game pieces resembling an alligator (i.e., alligator resembling game piece 130), and a game piece including indicia designating an alligator pit (i.e., an alligator pit designating game piece 132). The lily pad resembling game piece 122, the cat-tail resembling game piece 124 and the alligator resembling game piece 130 each are an example of a life form that can inhabit a pond (i.e., a water body).

As shown in FIG. 2 and as is discussed below in greater detail in reference to game play instructions, each one of the game pieces of the path defining game piece set 108 can be used for creating circuitous game play path along which the player indicating game pieces 102 move during game play. Furthermore, certain path defining game pieces of the path defining game piece set 108 can be used for implementing a different game play action (i.e., functionality) when a player's player indicating game piece 102 lands thereon. For example, each lily pad resembling game pieces 122 can have provided thereon information designating an action to be taken by a player in response to the player answering a question correctly when the turtle resembling game piece 102 of the player comes to rest on the lily pad resembling game piece 122 during a play instance of the player. Similarly, a cat-tail resembling game piece 124 can have provided thereon information designating at least one game piece of a collectible game piece set to be collected by a player when the turtle resembling game piece 102 of the player comes to rest on the cat-tail resembling game piece 124 during a play instance of the player. In one embodiment, collection of a sufficient number and/or combination of collectible game pieces can be necessary for winning a game. It is also disclosed herein that the alligator resembling game piece 130 and the alligator pit designating game piece 132 can be jointly used to provide a penalty situation for a player. For example, when a turtle resembling game piece 102 of a player comes to rest on the alligator resembling game piece 130 during a play instance of the player, instructions for the game can require that the turtle resembling game piece of the player move backwards to the alligator pit designating game piece 132, thus effectively loosing a turn.

Turning now to a discussion of instructions for playing a game in accordance with the present invention, in one embodiment, the objective of playing the game is to be the first player or team of players to circulate the game path defined by the game path defining game pieces (e.g., as shown in FIG. 2), to collect all of the collectible game pieces required for winning (e.g., the entire collectible game piece set), and cross the finish line (e.g., as designated by the a finish location designating game piece 128). To this end, groups of players can be split into teams or play as individuals. For educational purposes such as in a classroom, grouping students as teams can be preferred, if not beneficial. For example, a class can be split into two teams with each team member of a first team being assigned a turtle resembling game piece 102 of a first color or number series (e.g., even numbers) and each team member of a second team being assigned a turtle resembling game piece 102 of a second color or number series (e.g., odd numbers). Optionally, a single turtle resembling game piece 102 can be assigned to each team and teams play through use of a single player indicating game piece. To determine which teams moves first, a method such as deciding which student has the next up-coming birthday of all students in the two teams can be used (e.g., the team having the student with the next up-coming birthday moves first). The number of path defining game pieces that a turtle resembling game piece 102 of a team moves can be determined using any suitable means for generating a number (e.g., dice, spinning pointer, digital random number generator, etc). During play, the turtle resembling game pieces 102 all move around the circuitous game path in a single direction (e.g., clock-wise in the game path shown in FIG. 2). Collectible game pieces are gathered while playing the game. When all necessary pieces have been collected, the team (or individual if not playing on a team basis) can proceed across the bridge for the final race to finish line.

In one specific embodiment of the present invention, each team has a group of game pieces to collect to build a bridge, a flower, and 6 cat tails. The game pieces are as follows: bridge pieces (e.g., 13 pieces), cat tail stems (e.g., 6 pieces), cat tail flower tops (e.g., 6 pieces), flower pieces (e.g., 8 pieces), and insect resembling game pieces (e.g., 1 piece to a player only when player goes past the start location designating game piece 126). Every time a player passes the start location designating game piece 126, they will collect an insect resembling game piece 118 whose color and or shape corresponds to the team they are on (if on a team). After a designated number of team mates (e.g., 5) collect an insect resembling game piece 118 for their team, the collected insect resembling game pieces can be traded in for a game piece of choice (e.g., a game piece not yet otherwise collected).

With respect to the cat-tail like game pieces, when a player lands on a first section 133 of the cat-tail like game piece 124, the team (or player) receives a collectible cat-tail game piece of their choice (e.g., cat-tail flower resembling game pieces 114 or a plurality of cat-tail stem resembling game pieces 116) and, when the player lands on a second section 134 of the cat-tail like game piece 124, the team (or player) receives a collectible cat-tail game piece of their choice (e.g., cat-tail flower resembling game pieces 114 or a plurality of cat-tail stem resembling game pieces 116) and one bridge segment resembling game piece 112. If a player is sent to a cat-tail resembling game-piece by another portion of such instructions (e.g., as instructed to do so as a result of landing on another path defining game piece), the player will land on section of the cat-tail resembling game piece 124 as directed.

With respect to the lily-pad resembling game pieces 122, a player must land on the lily pad resembling game piece in order to read directions on card. In one embodiment, such directions include information designating an action to be taken by the player in response to the player answering a question correctly. Question can be provided by a person such as a teacher or the other team or from a collection of pre-printed questions (e.g., question cards). The question can be question and directions can be read out loud so everyone hears them, followed by the player (or optionally the players team or a team mate) answers the question. The player follows directions on the card depending on whether or not the question is correctly answered (e.g., move forward x spaces or collect a collectible game piece if answer is correct, move back y spaces or loose a collectible game piece if answer is not correct, etc).

It is disclosed herein that a game facilitator (e.g., a teacher) can prepare curriculum and/or subject specific query cards that are used as the questions within the game. For example, question cards used when a player lands on a lily pad resembling game piece can be created for various subjects (e.g., 1. spelling; 2. science; 3. math; 4. history; 5 geography; 6. etc.) One or more subjects can be use in a game. These question cards can be separate cards of pieces of paper that the game facilitator keeps and, as the need for questions arise throughout the game, the questions will be read to the player needing such a question.

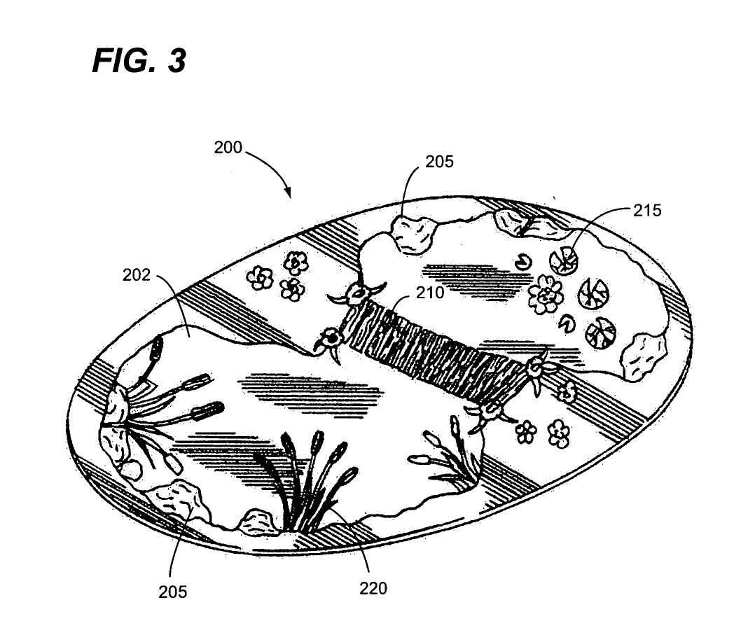

Referring now to FIG. 3, a game substrate 200 configured in accordance with the present invention is shown. The game substrate has provided thereon indicia visually representing a pond 202 (i.e., a water body, which is an example of an environmental system). The indicia includes indicia visually resembling a plurality of rocks (i.e., rock resembling indicia 205) exposed at a surface of water of the pond, indicia visually resembling a plurality of logs exposed at the surface of the water (i.e., log resembling indicia 210) that are in an arrangement to serve as bridge segments extending across the pond), indicia visually resembling a plurality lily pads exposed at the surface of the water (i.e., lily pad resembling indicia 215), and indicia visually resembling a plurality of cat-tail clusters exposed at the surface of the water (i.e., cat-tail cluster resembling indicia 220).

In a preferred embodiment, the game substrate 200 can be a rug or floor mat. For example, the game substrate 200 can be a rug used for decorating the floor of a classroom or used for bringing a class together for reading time or group activities. Advantageously, the game substrate can be used in combination with at least a portion of the game piece collection 100 discussed above in reference to FIGS. 1 and 2. Use of game pieces of the game piece collection 100 (e.g., rock, resembling game pieces 120, lily pad resembling game pieces 122, cat-tail resembling game pieces 124, start indicia designating game piece 126, finish indicia designating game piece 128, alligator resembling game piece 130, and alligator pit designating game piece 132) as accessories to the game substrate turn the game substrate from rug or floor mat into a game board. For example, the rock resembling indicia 205 provide extra game path spaces in combination with the rock resembling game pieces 120 and the rock resembling game pieces 120 can be places in different locations on the game substrate 200 every time the game is played, thus changing the dynamics of game play. To this end, instructions configured in accordance with the present invention can be configured to specify a manner in which various game pieces of the game piece collection 100 can be arranged on the game substrate 200 in conjunction with the indicia provided on the game substrate 200 to form a game path.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A game, comprising:
a plurality of game pieces each visually resembling a turtle, wherein each one of said turtle resembling game pieces is distinctly identified for allowing each player of said game to be associated with a respective one of said turtle resembling game pieces;
a plurality of game pieces visually resembling a rock;
at least one game pieces visually resembling a lily pad;
at least one game pieces visually resembling a cluster of cat-tails; and
a tangible medium having instructions provided thereon, wherein said instructions specify a manner in which said rock resembling game pieces, said at least one lily pad resembling game piece and said at least one cat-tail cluster resembling game piece can be arranged to form a game path along which said turtle resembling game pieces are to be moved.

2. The game of claim 1 wherein said at least one lily pad resembling game pieces has provided thereon information designating an action to be taken by a player in response to the player answering a question correctly.

3. The game of claim 1, further comprising:
a plurality of collectible game piece sets, wherein each one of the collectible game pieces of a particular one of said collectible game piece sets is visually identifiable as belonging to the particular one of said collectible game piece sets and wherein said instructions further specify a manner in which at least one of said game pieces of a particular set of said collectible game pieces is associated with the game path for winning the game.

4. The game of claim 3 wherein said at least one cat-tail resembling game piece has provided thereon information designating at least one of said collectible game pieces to be collected by a player when a turtle resembling game piece of the player comes to rest on said at least one cat-tail resembling game piece during a play instance of the player.

5. The game of claim 4 wherein said at last one lily pad resembling game piece has provided thereon information designating an action to be taken by the player in response to the player answering a question correctly.

6. The game of claim 1, further comprising:
a first penalty game piece visually distinct from any of said other game pieces, wherein said instructions specify a manner in which the first penalty game piece can be included within the game path; and
a second penalty game piece visually distinct from any of said other game pieces, wherein said instructions specify a manner in which the second penalty game piece can be included within the game path, specify that a turtle resembling game piece landing on said first penalty game piece shall immediately move directly to the second penalty game piece from the first penalty game piece, and specify an action to be taken as a result of such movement to the second penalty game piece.

7. The game of claim 6 wherein:
the first penalty game piece visually resembles an alligator; and
the second penalty game piece has provided thereon indicia designating “Gator Pit”.

8. The game of claim 7, further comprising:
a plurality of collectible game piece sets;
wherein each one of said collectible game piece sets of a particular one of said collectible game piece sets is visually identifiable as belonging to the particular one of said collectible game piece sets;
wherein said instructions further specify a manner in which at least one of said game pieces of a particular set of said collectible game pieces is associated with the game path for winning the game;
wherein said at least one cat-tail resembling game pieces has provided thereon information designating at least one of said collectible game pieces to be collected by a player when a turtle resembling game piece of the player comes to rest on said at least one cat-tail resembling game piece during a play instance of the player; and
wherein said at least one lily pad resembling game piece has provided thereon information designating an action to be taken by the player in response to the player answering a question correctly.

9. A game, comprising:
a game substrate having provided thereon indicia visually representing a water body, wherein said indicia includes indicia visually resembling a plurality of rocks exposed at a surface of water of the water body, indicia visually resembling at least one log exposed at the surface of said water, indicia visually resembling at least one lily pad exposed at the surface of said water, and indicia visually resembling at least one cat-tail cluster exposed at the surface of said water;
a plurality of first configuration game pieces each visually resembling a first life form inhabiting a water body, wherein each one of said first configuration game pieces is distinctly identified for allowing each player of said game to be associated with a respective one of said first configuration game pieces;
at least one second configuration game piece visually resembling a second life form inhabiting the water body, wherein said at least second configuration game piece has provided thereon information designating an action to be taken by a player in response to the player answering a question correctly;
a plurality of collectible game piece sets, wherein each one of said collectible game piece sets of a particular one of said collectible game piece sets is visually identifiable as belonging to the particular one of said collectible game piece sets;
at least one third configuration game piece visually resembling a third life form inhabiting the water body, wherein said at least one third configuration game piece has provided thereon information designating at least one of said collectible game pieces to be collected by a player when a respective one of said first configuration game pieces of the player comes to rest on said at least one third configuration game piece during a play instance of the player; and
a tangible medium having instructions provided thereon, wherein said instructions specify a manner in which said second and third configuration game pieces can be arranged on the game substrate in conjunction with said indicia provided on the game substrate to form a game path along which said first configuration game pieces are to be moved.

10. The game of claim 9 wherein the game substrate is in the form of a rug or floor mat.

11. The game of claim 9, further comprising:
a fourth configuration game piece visually distinct from any of said other game pieces, wherein said instructions specify a manner in which said fourth configuration game piece can be included within the game path; and
a fifth configuration game piece visually distinct from any of said other game pieces, wherein said instructions specify a manner in which said fifth configuration game piece can be included within the game path, that one of said first configuration game pieces landing on the fourth configuration game piece shall immediately move directly to the fifth configuration game piece from the fourth configuration game piece, and an action to be taken as a result of such movement to the fifth configuration game piece.

12. The game of claim 11 wherein:
each one of said first configuration game pieces visually resembles a turtle;
said at least one second configuration game piece visually resembles a cluster of cat-tails;
said at least one third configuration game piece visually resembles a lily pad;
the fourth configuration game piece visually resembles an alligator; and
the fifth configuration game piece has provided thereon indicia designating “Gator Pit”.

13. The game of claim 12 wherein the game substrate is in the form of a rug or floor mat.

14. The game of claim 9 wherein:
each one of said first configuration game pieces visually resembles a turtle;
said at least one second configuration game piece visually resembles a cluster of cat-tails; and
sad at least one third configuration game piece visually resembles a lily pad.

15. A game, comprising:
a plurality of first configuration game pieces each visually resembling a first life form inhabiting a water body, wherein each one of said first configuration game pieces is distinctly identified for allowing each player of said game to be associated with a respective one of said first configuration game pieces;
at least one second configuration game piece visually resembling a second life form inhabiting the water body;
at least one third configuration game piece visually resembling a third life form inhabiting the water body;
a plurality of fourth configuration game pieces visually resembling a structure that extends above a surface of the water body and upon which the first life form can rest; and
a tangible medium having instructions provided thereon, wherein said instructions specify a manner in which said at least one second configuration game piece, said at least one third configuration game piece, and said fourth configuration game pieces can be arranged to form a game path along which said first configuration game pieces are to be moved.

16. The game of claim 15 wherein said at least one second configuration game pieces has provided thereon information designating an action to be taken by a player in response to the player answering a question correctly.

17. The game of claim 16, further comprising:
a plurality of collectible game piece sets, wherein each one of said collectible game piece sets of a particular one of said collectible game piece sets is visually identifiable as belonging to the particular one of said collectible game piece sets and wherein said instructions further specify a manner in which at least one of said game pieces of a particular set of said collectible game pieces is associated with the game path for winning the game.

18. The game of claim 17 wherein said at least one third configuration game piece has provided thereon information designating at least one of said collectible game pieces to be collected by a player when a first configuration game piece of the player comes to rest on the third configuration game piece during a play instance of the player.

19. The game of claim 18 wherein said at least one second configuration game pieces has provided thereon information designating an action to be taken by the player in response to the player answering a question correctly.

20. The game of claim 19, further comprising:
a fifth configuration game piece visually distinct from any of said other game pieces, wherein said instructions specify a manner in which the fifth configuration game piece can be included within the game path; and
a sixth configuration game piece visually distinct from any of said other game pieces, wherein said instructions specify a manner in which the sixth configuration game piece can be included within the game path, specify that one of said first configuration game pieces landing on said fifth configuration game piece shall immediately move directly to the sixth configuration game piece from said fifth configuration game piece, and an action to be taken as a result of such movement to the sixth configuration game piece;
wherein the fifth configuration game piece visually resembles an alligator; and
wherein the sixth configuration game piece has provided thereon indicia designating “Gator Pit”.
